(19) United States
(12) Patent Application Publication
(10) Pub. No.: US 2009/0050711 A1
(43) Pub. Date: Feb. 26, 2009

(54) Variable and regulated animal scent dispenser

(76) Inventor: Michael Castner, Dallas, PA (US)

Correspondence Address: RICHARD L. BIGELOW, 203 TREMONT STREET, NEWINGTON, CT, 06111, US

(21) Appl. No.: 12/228,958

(22) Filed: Aug. 18, 2008

Related U.S. Application Data
(60) Provisional application No. 60/957,719, filed on Aug. 24, 2007.

(51) Int. Cl. B05B 9/08; B67D 5/42; B05B 7/26; A01M 31/00

(52) U.S. Cl. 239/152; 239/310; 222/372; 43/1

(57) ABSTRACT

A variable and regulated animal scent dispenser that allows a hunter or tracker to dispense discrete and variable amounts of animal or other scent in a continuous manner while walking through a forest or field. The lower part of the device is attached to the underside of a hunter's boot; the upper part of the device is clipped on to the top of the hunter's boot. As the hunter walks through the woods, the sole of his boot presses down on the compressible bladder, thereby sending air through a rubber or plastic tube to a manifold. Depending on the position of the manifold/regulator switch, the compressed air either bypasses a scent receptacle or enters the scent receptacle. If the compressed air enters the scent receptacle, it picks up particles of scent and transports them out the discharge tube and ultimately to the atomizer at the end of the tube. Scent is then dispersed through the atomizer onto the ground. This allows for a fairly continuous stream of scent. The hunter can vary the amount of scent that is dispersed through the atomizer by adjusting the manifold.

### CROSS REFERENCE TO RELATED APPLICATIONS

This non-provisional application claims priority from U.S. Provisional Patent Application 60/957,719 filed on Aug. 24, 2007.

### FEDERAL RESEARCH STATEMENT

None

### BACKGROUND OF THE INVENTION

This invention relates to a device whereby a hunter in the outdoors can easily and quietly dispense animal scents or human blocking scents while walking through a forest or field. The scent can be dispensed in variable amounts in various places as the hunter moves through the forest or field.

### DESCRIPTION OF THE PRIOR ART

Hunters and trackers use scents to assist them in tracking and hunting game animals. Some animal scents are used to attract game to the location the hunter or tracker desires. Other scents are used to mask natural odors associated with the hunter that would otherwise warn the animal of the hunter's presence and thereby cause the animal to avoid the hunter or tracker.

The prior art teaches several distinct types of devices used to dispense animal or human masking scents in the outdoors. For example, U.S. Pat. No. 7,108,199 to Brown teaches a scent dispensing device that is placed in a static configuration on a tree. U.S. Pat. No. 6,966,500 to Kelley also teaches a static tree-based scent dispenser. The devices disclosed in these patents have the obvious limitation of being stationary and is not adjustable so that the amount of scent can be varied.

U.S. Pat. No. 7,093,770 to Moran teaches a scent dispenser that is dragged behind the foot of a hunter or tracker. The Moran patent solves the problem of being stationary, but has the problem of not being adjustable. In addition, when the device becomes wet, the scent can be diluted and therefore become ineffective.

Similarly, U.S. Pat. No. 4,735,010 to Grinarmi suggests positioning a tubular dispenser within the arch on the underside of a hunter's boot, the tube being held in place by a tie extending the laces of the boot. The problem, however, is that, so positioned, the device is all the more exposed to mud and rain puddles rendering the device less effective and reducing its effective life.

The instant invention solves the problems inherent in the above mentioned prior art by being mobile, allowing for variable amounts of scent to be dispensed, allowing different types of scent to be dispensed, and allowing virtually hands free dispersal of scent.

### SUMMARY OF THE INVENTION

The present invention is directed toward a device that allows a hunter or tracker to dispense discrete and variable amounts of animal or other scent in a continuous manner while walking through a forest or field. The lower part of the device is attached to the underside of a hunter's boot; the upper part of the device is clipped, strapped, or attached in some other manner onto the top of the hunter's boot. As the hunter walks through the woods or a field, the sole of his or her boot presses down on the compressible bladder, thereby sending air through a rubber or plastic tube to a manifold. Depending on the position of the manifold/regulator switch, the compressed air either bypasses the scent receptacle or enters the scent receptacle. If the compressed air enters the scent receptacle, it picks up particles of scent and transports them out the discharge tube and ultimately to the atomizer at the end of the tube. Scent is then dispersed through the atomizer onto the ground. This allows for a fairly continuous stream of scent. The hunter can vary the amount of scent that is dispersed through the atomizer by adjusting the manifold.

### BRIEF DESCRIPTION OF DRAWINGS

FIG. 1 shows a side view of the Regulated and Variable Scent Dispenser 10 on a hunter's boot 80. Key components are the compression bladder 110, scent receptacle 40, manifold/regulator 30, and atomizer 100. The pressure of the hunter's boot on the compression bladder 110 sends compressed air through an air tube 70 and either bypasses the scent receptacle 40 or goes through the scent receptacle where it picks up some scent molecules and moves it through the discharge tube 50 and finally out the atomizer 100. The hunter controls the flow of animal scent by using the manifold/regulator 30. The scent receptacle 40 is modular and interchangeable so that different animal scents or human mask scents can be utilized.

### DETAILED DESCRIPTION OF THE INVENTION

The present invention is directed toward a simple mechanical device that a hunter can use to dispense animal scents or human blocking scents while walking in a forest or a field. While this invention can be used to attract any animal, for ease of understanding this invention will be discussed in the context of a deer hunter.

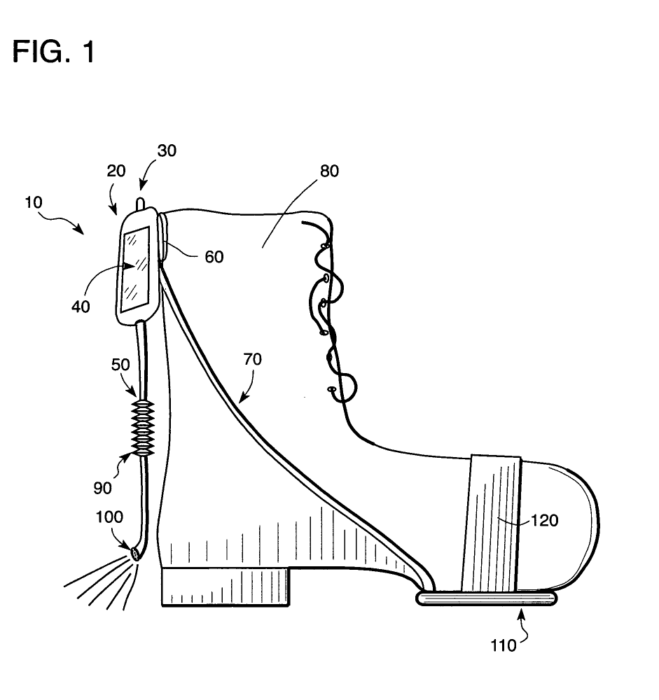

Referring to FIG. 1, a side view of the scent dispenser 10 on a hunter's boot 80 is shown. A strap 120 holds the compressible air bladder 110 in place on the undersole of the hunter's boot. As the hunter walks through the woods, the pressure of his weight on the air bladder forces compressed air out of the bladder into a rubber or plastic hose 70. The hose 70 travels up from the air bladder to a manifold/regulator 30 located approximately at the top of the hunter's boot. Depending on the manifold/regulator setting, the compressed air either enters the scent receptacle 40 or bypasses it. If the manifold/regulator is in the bypass mode, the air passes harmlessly into the atmosphere.

If the manifold/regulator is set such that some or all of the compressed air passes into the scent receptacle, the compressed air picks up some scent molecules, travels out of the receptacle into the upper discharge tube 50 and through the flexible compressible adjustment tube 90 and out the lower discharge tube and finally through the atomizer 100 where it is discharged in atomized form to the ground.

The manifold/regulator is adjustable and variable so that anywhere between 0% and 100% of the air can enter the scent receptacle. The more air that enters the scent receptacle, the stronger the scent will be that is deposited on the ground through the atomizer.

The flexible compressible adjustment tube 90 allows the hunter to adjust the discharge up and down depending on the height of the boot or even the height of the grass or underbrush that the hunter is walking through.

The scent receptacle 30 is modular so that the hunter can quickly and easily change out the receptacle and replace it with another receptacle with the same or another scent. For example, if the scent receptacle is empty, the hunter can quickly replace it with another of the same type of scent. Alternately, the hunter can quickly switch from an animal scent to a hunter masking or blocking scent.

The upper part of the device 10 is attached to the upper part of the boot by using a clip 60 a strap, or other similar simple mechanical attachment mechanism.

In an alternate mode, the bladder is attached to the front part of the sole of the hunter's boot using a Velcro strap. This allows for quicker removal and insertion of the bladder.

The novelty inherent in the present invention can be readily seen in a description of how a hunter would use the device in the field or forest. The hunter would attach the device to his boot as he enters the area he wants to hunt. Initially, he may have the manifold/regulator set in the bypass position so that no scent is dispersed. As he gets further into the hunting area, he may want to start to dispense some scent, so he adjusts the manifold/regulator slightly to allow some of the compressed air to enter the scent receptacle where it picks up some scent and is eventually dispersed through the atomizer to the ground. The hunter accomplishes the foregoing by simply reaching down and adjusting the regulating valve. The minimal motion and minimal associated noise allows the hunter to vary the scent as he desires without making an inordinate amount of noise which could scare deer away.

The following is claimed:

1. A variable and regulated animal scent dispenser comprising;
a. a compression bladder,
b. a scent receptacle,
c. a manifold/regulator
d. an atomizer,
e. tubing that connects the above components, and
f. methods for fixedly attaching the above components to a hunter's boot or shoe.

2. A variable and regulated animal scent dispenser as in claim 1 where the scent receptacle is interchangeable with other scent receptacles.

3. A variable and regulated animal scent dispenser as in claim 1 where the compression bladder is situated on the underside of a boot.

4. A variable and regulated animal scent dispenser as in claim 1 where the scent receptacle is attached to the top of the hunter's boot.

5. A variable and regulated animal scent dispenser as in claim 1 which further comprises a flexible compressible adjustment tube.

6. A variable and regulated animal scent dispenser as in claim 1 where the manifold/regulator can adjust the amount of air entering the scent receptacle between 0% and 100%.
